(19) United States
(12) Patent Application Publication
(10) Pub. No.: US 2009/0147087 A1
(43) Pub. Date: Jun. 11, 2009

(54) Digital photo frame printer

(76) Inventors: Chien-Man Cheng, Tsao Tuen (TW); I-Ping Huang, Tsao Tuen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/000,109

(22) Filed: Dec. 10, 2007

(51) Int. Cl. H04N 5/225

(52) U.S. Cl. 348/207.2

(57) ABSTRACT

A digital photo frame printer includes a printer casing module, an image-capturing module, an image-processing module, an image-displaying module, and an image-printing module. The image-capturing module is disposed in the printer casing module for capturing images of external objects. The image-processing module is disposed in the printer casing module and electrically connected with the image-capturing module for processing the images that have been captured via the image-capturing module. The image-displaying module is disposed in the printer casing module and electrically connected with the image-processing module for displaying images that have been processed via the image-processing module. The image-printing module is disposed in the printer casing module and electrically connected with the image-processing module for printing images that have been processed via the image-processing module.

### BACKGROUND OF THE INVENTION

1. Field of the Invention

The present invention relates to a digital photo frame printer, and particularly relates to a digital photo frame printer with an image-capturing, an image-display, and an image-printing function.

2. Description of the Related Art

A digital photo frame is a kind of electronic product that has developed along with the current progress of computer and Internet technology. A conventional digital photo frame uses a display, such as an LCD, to display digital photos instead of the traditional photo frame.

However, the conventional digital photo frame cannot print the photos. Hence, users have to connect an external printer with the digital photo frame to print photos or have their photos developed at photo shops. Despite photo printers now being available for personal and household use, conventional photo printers cannot be used to display photos from a digital photo frame.

The inventor of the present invention recognizes that the above short coming should be corrected and a special effort has been paid to research this field. The present invention is presented with reasonable design and good effect to resolve the above problems.

### SUMMARY OF THE INVENTION

One particular aspect of the present invention is to provide a digital photo frame printer that is used to either browse or select digital photos on an image-display module and print the selected digital photos via an image-printing module for users. In addition, the digital photo frame printer can be hanged on a wall or placed on a desk as a framed photo or ornament. Hence, it is convenient for users to use the digital photo frame printer of the present invention.

Moreover, the digital photo frame printer uses an image-capturing module to capture images of external objects, uses the image-display module to display the images for the users to browse or select digital photos on the image-display module, and then uses the image-printing module to print out the images that are selected by the users. Hence, the digital photo frame printer of the present invention has both an immediate image-inputting function (immediate image-capturing function) and immediate image-outputting function (immediate image-displaying/printing function). For example, the digital photo frame printer can be applied to capture images immediately such as a passport or ID photographs.

Furthermore, the image-capturing module has a night shot function. Hence, the image-capturing module can capture images of the external objects at night or when lighting is insufficient.

In addition, the image-printing module has a built-in drum case integrated therein in order to reduce space occupied by the image-printing module. Hence, the digital photo frame printer of the present invention can be placed in any position and direction to print.

In order to achieve the above-mentioned aspects, the present invention provides a digital photo frame printer includes a printer casing module, an image-capturing module, an image-processing module, an image-displaying module, and an image-printing module.

Moreover, the image-capturing module is disposed in the printer casing module for capturing images of external objects. The image-processing module is disposed in the printer casing module and electrically connected with the image-capturing module for processing the images that have been captured via the image-capturing module. The image-displaying module is disposed in the printer casing module and electrically connected with the image-processing module for displaying images that have been processed via the image-processing module. The image-printing module is disposed in the printer casing module and electrically connected with the image-processing module for printing images that have been processed via the image-processing module.

Furthermore, the digital photo frame printer of the present invention further includes a motion-sensing module with a motion-recording function disposed in the printer casing module and electrically connected with the image-processing module for sensing motions of the external objects and ordering the image-processing module to drive the image-capturing module to capture the images of the external objects. In other words, when the external objects enter a sensing scope of the motion-sensing module, the motion-sensing module would drive the image-capturing module to capture the images of the external objects. In addition, the motion-sensing module can be an infrared sensor, a microwave sensor, a temperature sensor, or a sound sensor.

Therefore, the digital photo frame printer of the present invention has the following advantages:
1. The digital photo frame printer can be hanged on a wall or placed on a desk as a framed photo or ornament;
2. The digital photo frame printer is used to either browse or select digital photos on the image-display module and print the selected digital photos via the image-printing module for the users;
3. The digital photo frame printer can capture the images on-the-spot and print out the images immediately. For example, when a businessman proceeds business transactions or a police handles a case, the digital photo frame printer can be used to capture images as evidences;
4. The built-in drum case is integrated in the image-printing module. Hence, the digital photo frame printer can be placed in any position and direction to print;
5. The motion-sensing module, the image-capturing module, and the image-displaying module are mated with each other to produce a monitor function in the daytime or the night, or when there is not enough light; and
6. The digital photo frame printer can browse and print the images directly without storing the images in a computer first as in the prior art. Hence, it is simple for the users to operate the digital photo frame printer of the present invention.

Hence, the present invention provides a three-in-one digital photo frame printer with browse, print and monitor functions. Therefore, the digital photo frame printer can be a digital camera, a monitor, or a framed photo or ornament hanged on a wall or placed on a desk.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is an exploded view of a digital photo frame printer of the present invention; and

FIG. 2 is a function block of a digital photo frame printer of the present invention.

### DETAILED DESCRIPTION OF THE PREFERRED EMBODIMENTS

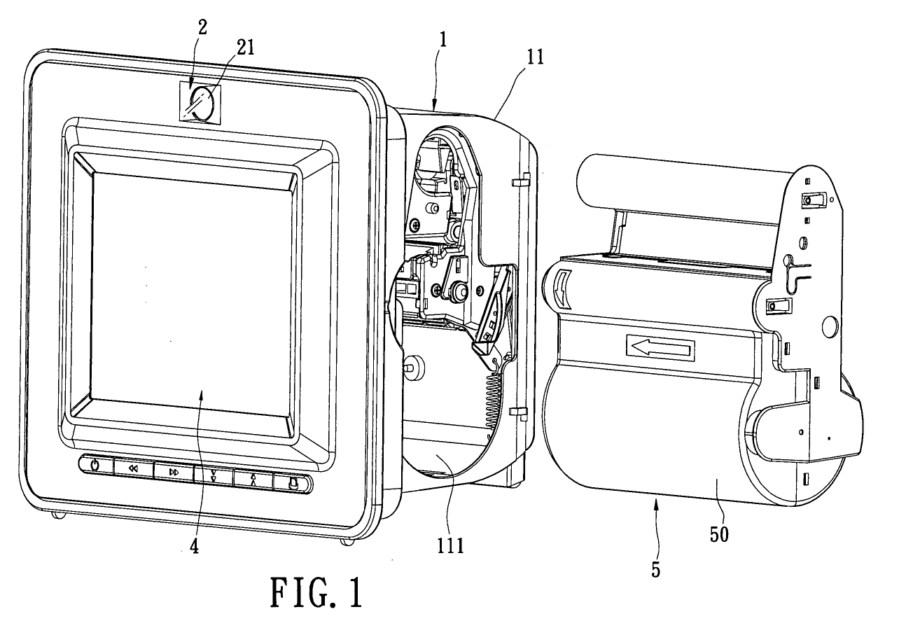

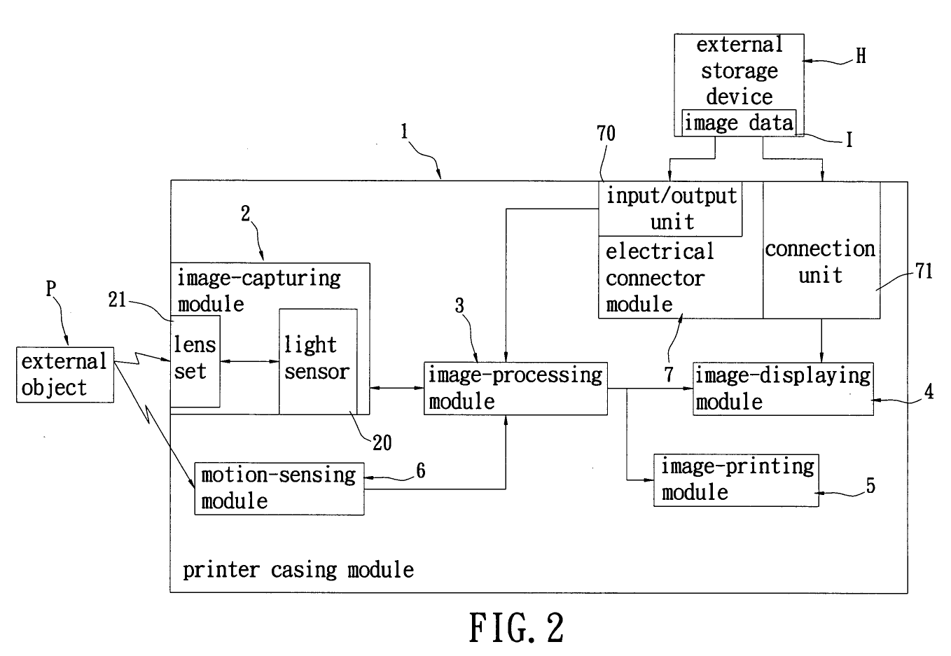

Referring to FIGS. 1-2, FIG. 1 is shows exploded view of a digital photo frame printer of the present invention, and FIG. 2 shows a function block of a digital photo frame printer of the present invention. The present invention provides a digital photo frame printer, including: a printer casing module 1, an image-capturing module 2, an image-processing module 3, an image-displaying module 4, and an image-printing module 5.

Moreover, the printer casing module 1 has a main body 11 and a accommodating space 111 formed therein. The main body 11 is a hollow casing.

Furthermore, the image-capturing module 2 is disposed in the printer casing module 1 for capturing images of external objects P. The image-capturing module 2 has a light sensor 20 and a lens set 21 connected with the light sensor 20. The light sensor 20 can be a CCD (Charge-Coupled Device) sensor or a CMOS (Complementary Metal Oxide Semiconductor) sensor, and the lens set 21 is exposed out of the printer casing module 1. The image-capturing module 2 can be a camera or a video camera, and the image-capturing module 2 can be an image-capturing device for automatically or manually adjusting an image-capturing angle and an image-capturing focal length. In other words, according to different positions of the external objects P, the image-capturing angle and the image-capturing focal length of the image-capturing module 2 are adjusted by a user looking the images in the image-displaying module 4 in order to capture satisfied image data.

In addition, the image-capturing module 2 has a night shot function. For example, the image-capturing module 2 has a plurality of infrared rays LEDs (not shown) projected onto the external objects P when there is not enough light, and the light sensor 20 receives the reflective light from the external objects P to assist to capture images of the external objects P. Hence, the image-capturing module 2 can capture images of the external objects P at night or when lighting is insufficient. Besides, the image-capturing module 2 having other functions for night shot is protected in the present invention.

Moreover, the image-processing module 3 is disposed in the printer casing module 1 and electrically connected with the image-capturing module 2 for processing the images that have been captured via the image-capturing module 2. In addition, the image-processing module 3 has some functions, as follows:
1. The image-processing module 3 can be an interface between the image-capturing module 2 and the image-displaying module 4 and between the image-capturing module 2 and the image-printing module 5;
2. The images that have been captured via the image-capturing module 2 are stored in the image-processing module 3;
3. The images that have been captured via the image-capturing module 2 are received (input) by the image-processing module 3, and the images that have been processed via the image-processing module 3 are transmitted (output) to the image-displaying module 4 or the image-printing module 5;
4. The image-processing module 3 can drive the image-capturing module 2 to capture images; and
5. The image-processing module 3 can drive the image-printing module 5 to print out images.

Furthermore, the image-displaying module 4 is disposed in the printer casing module 1 and electrically connected with the image-processing module 3 for displaying images that have been processed via the image-processing module 3. In addition, the image-displaying module 4 can be an LCD (Liquid Crystal Display) or a touch screen display.

In addition, the image-printing module 5 can be a thermal transfer printer, and the image-printing module 5 is disposed in the printer casing module 1 and electrically connected with the image-processing module 3 for printing images that have been processed via the image-processing module 3. Moreover, the image-printing module 5 is received in the accommodating space 111 of the printer casing module 1, and the image-printing module 5 has a built-in drum case in order to make the image-printing module 5 print images in any position and direction. In other words, the digital photo frame printer of the present invention can proceed print in any set position and set direction due to above-mentioned feature of image-printing module 5 that is received in the accommodating space 111 of the printer casing module 1.

Moreover, the digital photo frame printer of the present invention further includes a motion-sensing module 6 with a motion-recording function disposed in the printer casing module 1 and electrically connected with the image-processing module 3 for sensing motions of the external objects P and ordering the image-processing module 3 to drive the image-capturing module 2 to capture the images of the external objects P. In other words, when the external objects P enter a sensing scope of the motion-sensing module 6, the motion-sensing module 6 would drive the image-capturing module 2 to capture the images of the external objects P. In addition, the motion-sensing module 6 can be an infrared sensor, a microwave sensor, a temperature sensor, or a sound sensor.

Furthermore, the digital photo frame printer of the present invention further includes an electrical connector module 7 disposed in the printer casing module 1 and electrically connected with the image-processing module 3. The image-processing module 3 makes image data that is stored in an external storage device H pass through the electrical connector module 7 and displayed on the image-displaying module 4 or printed out from the image-printing module 5. In addition, the electrical connector module 7 has an input/output unit 70 (such as USB interface or memory slot) electrically connected with the image-processing module 3 and a connection unit 71 (such as S terminal or AV terminal) electrically connected with the image-displaying module 4.

In conclusion, the digital photo frame printer is used to either browse or select digital photos on the image-display module 4 and print the selected digital photos via the image-printing module 5 for users. In addition, the digital photo frame printer can be hanged on a wall or placed on a desk as a framed photo or ornament. Hence, it is convenient for users to use the digital photo frame printer of the present invention.

Moreover, the digital photo frame printer uses the image-capturing module 2 to capture the images of the external objects P, uses the image-display module 4 to display the images for the users to browse or select digital photos on the image-display module 4, and then uses the image-printing module 5 to print out the images that are selected by the users. Hence, the digital photo frame printer of the present invention has both an immediate image-inputting function (immediate image-capturing function) and immediate image-outputting function (immediate image-displaying/printing function). For example, the digital photo frame printer can be applied to capture images immediately such as mug shot for police or ID photo.

Furthermore, the image-capturing module has a night shot function. Hence, the image-capturing module 6 mated with the image-capturing module 2 can capture images of the external objects P at night or when lighting is insufficient. The image-capturing module 6 is used to sense motions of the external objects P and ordering the image-processing module 3 to drive the image-capturing module 2 to capture the images of the external objects P in order to produce a monitor function.

In addition, the image-printing module 5 has a built-in drum case integrated therein in order to reduce space occupied by the image-printing module 5. Hence, the digital photo frame printer of the present invention can be placed in any position and direction to print.

Therefore, the digital photo frame printer of the present invention has the following advantages:
1. The digital photo frame printer can be hanged on a wall or placed on a desk as a framed photo or ornament;
2. The digital photo frame printer is used to either browse or select digital photos on the image-display module 4 and print the selected digital photos via the image-printing module 5 for the users;
3. The digital photo frame printer can capture the images on-the-spot and print out the images immediately. For example, when a businessman proceeds business transactions or a police handles a case, the digital photo frame printer can be used to capture images as evidences;
4. The built-in drum case 50 is integrated in the image-printing module 5. Hence, the digital photo frame printer can be placed in any position and direction to print;
5. The motion-sensing module 6, the image-capturing module 2, and the image-displaying module 4 are mated with each other to produce a monitor function in the daytime or the night, or when there is not enough light; and
6. The digital photo frame printer can browse and print the images directly without storing the images in a computer first as in the prior art. Hence, it is simple for the users to operate the digital photo frame printer of the present invention.

Hence, the present invention provides a three-in-one digital photo frame printer with browse, print and monitor functions. Therefore, the digital photo frame printer can be a digital camera, a monitor, or a framed photo or ornament hanged on a wall or placed on a desk.

Furthermore, the digital photo frame printer of the present invention can be used for an individual user or a family to print out photos, the present invention also can be applied to commercial presentation and can print out urgent photos immediately and quickly for reference without going to a photo studio to develop the photos.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A digital photo frame printer, comprising:
a printer casing module;
an image-capturing module disposed in the printer casing module for capturing images of external objects;
an image-processing module disposed in the printer casing module and electrically connected with the image-capturing module for processing the images that have been captured via the image-capturing module;
an image-displaying module disposed in the printer casing module and electrically connected with the image-processing module for displaying images that have been processed via the image-processing module; and
an image-printing module disposed in the printer casing module and electrically connected with the image-processing module for printing images that have been processed via the image-processing module.

2. The digital photo frame printer as claimed in claim 1, wherein the image-capturing module is an image-capturing device for automatically or manually adjusting an image-capturing angle and an image-capturing focal length.

3. The digital photo frame printer as claimed in claim 1, wherein the image-capturing module has a light sensor and a lens set connected with the light sensor.

4. The digital photo frame printer as claimed in claim 3, wherein the light sensor is a CCD (Charge-Coupled Device) sensor.

5. The digital photo frame printer as claimed in claim 3, wherein the light sensor is a CMOS (Complementary Metal Oxide Semiconductor) sensor.

6. The digital photo frame printer as claimed in claim 3, wherein the image-capturing module has a night shot function.

7. The digital photo frame printer as claimed in claim 1, wherein the image-displaying module is an LCD (Liquid Crystal Display) or a touch screen display.

8. The digital photo frame printer as claimed in claim 1, wherein the image-printing module has a built-in drum case.

9. The digital photo frame printer as claimed in claim 1, wherein the image-printing module is a thermal transfer printer.

10. The digital photo frame printer as claimed in claim 1, further comprising a motion-sensing module disposed in the printer casing module and electrically connected with the image-processing module for sensing motions of the external objects and ordering the image-processing module to drive the image-capturing module to capture the images of the external objects.

11. The digital photo frame printer as claimed in claim 9, wherein the motion-sensing module is an infrared sensor, a microwave sensor, a temperature sensor, or a sound sensor.

12. The digital photo frame printer as claimed in claim 1, further comprising an electrical connector module disposed in the printer casing module and electrically connected with the image-processing module, wherein the image-processing module makes image data that is stored in an external storage device pass through the electrical connector module and displayed on the image-displaying module or printed out from the image-printing module.

13. The digital photo frame printer as claimed in claim 12, wherein the electrical connector module has an input/output unit electrically connected with the image-processing module and a connection unit electrically connected with the image-displaying module.
